(19) United States
(12) Patent Application Publication
(10) Pub. No.: US 2015/0208657 A1
(43) Pub. Date: Jul. 30, 2015

(54) USE OF QUINONE COMPOUND IN BUILDING MATERIALS

(71) Applicant: Arkion Life Sciences, LLC, New Castle, DE (US)

(72) Inventor: Kenneth E. Ballinger, JR., Kennett Square, PA (US)

(73) Assignee: Arkion Life Sciences, LLC, New Castle, DE (US)

(21) Appl. No.: 14/607,561

(22) Filed: Jan. 28, 2015

Related U.S. Application Data
(60) Provisional application No. 61/932,450, filed on Jan. 28, 2014.

(51) Int. Cl. A01N 45/02; B05D 1/18; B27K 3/38; C08K 5/08

(52) U.S. Cl. CPC A01N 45/02; C08K 5/08; B05D 1/18; B27K 3/38

(57) ABSTRACT

The present disclosure relates to the use of various quinones to protect building materials from bird, pest and/or fungal damage. In particular, the disclosure relates to incorporating one or more quinone compounds in a building material to deter birds, pests or fungi from damaging such material.

### CROSS-REFERENCE TO RELATED APPLICATIONS

This application claims priority to U.S. Provisional Application No. 61/932,450 filed Jan. 28, 2014, the contents of which is incorporated herein by reference in its entirety.

### FIELD OF THE TECHNOLOGY

The present disclosure relates to the use of a quinone compound to protect building materials from bird, pest or fungal damage. In particular, the disclosure relates to incorporating one or more quinone compounds in a building material to deter birds, pests or fungi from damaging such material.

### BACKGROUND

Building materials, both wood containing (or cellulosic based) and non wood containing, are susceptible for damage caused by birds, pests or fungi. For example, various bird species have recently adapted to man made building materials as a preferred substitute for their natural habitat. Acorn woodpecker (Melanerpes formiciverous) have begun to use recycled plastic components formed into architectural trim and artificial stucco for a variety of purposes. FIG. 1 shows a photograph of Acorn woodpeckers drilling into a piece of window trim made from recycled plastic to store acorns. The birds can cause significant damage to a home.

Similarly, pileated woodpeckers (Dryocopus pileatus) have been using western power poles as nest boxes. The pileated woodpecker is a crow sized woodpecker with a very strong bill. With their size and power, they are able to carve very large holes in utility poles. These holes cause significant structural damage and weaken the pole. Downy woodpeckers (Picoides pubescens) and hairy woodpeckers (Picoides villosus) are known to attack cedar siding of homes and cedar shake siding. These birds use the siding for nests and to make loud noises for matting in the spring.

Other pests and fungi can also cause damage to wood containing materials. For example, termites and white rot fungus are two causes of wood degradation in power poles. Both can slowly digest wood and severely damage and weaken these structures. In the past, these materials were treated with hazardous products to protect against degradation. Some of these treatments include chromated copper arsenate (CCA) or other petroleum-based products. These treatments are not very environmentally friendly. The present disclosure relates to the treatment of wood containing (and some non wood containing materials) with a quinone compound which is more environmentally friendly.

Surface treatment of food sources and perching areas using quinones is known. U.S. Pat. No. 6,324,986 is directed to a method for deterring birds from perching on plant and structural surfaces. U.S. Pat. No. 7,488,493 is directed to a performance aid composition to improve the effectiveness of 9,10-anthraquinone as a pest control. These references teach deterring birds by providing a visual cue to signal the birds to avoid the treated food source or perching area. They also teach deterring birds by transfer of surface quinone from feet/feathers to the open beak. They do not teach deterrence using a quinone compound present beneath the surface of a material and unavailable for visual inspection or transfer. When birds dig or peck at surfaces, the beak is closed and the constant wiping of the beak removes any unwanted substances from the bill or talons prior to eating.

### SUMMARY

The present disclosure relates to the use of a quinone compound to protect building materials from bird, pest or fungal damage.

In one embodiment, the present disclosure relates to a method of reducing or preventing damage to a wood containing substrate, the method including applying to a surface of the substrate a first solution containing a water soluble quinone compound to form a wetted substrate, such that the water soluble quinone compound penetrates beneath the surface of the substrate, and converting the water soluble quinone compound to a water insoluble quinone compound, or derivative thereof.

In another embodiment, the present disclosure relates to a method of reducing or preventing damage to a wood containing power pole, the method including soaking the power pole in an anthrahydroquinone solution having a pH of greater than about 7 to form a wetted power pole, such that the anthrahydroquinone penetrates beneath the surface of the power pole, and converting the anthrahydroquinone beneath the substrate surface to 9,10-anthraquinone.

In another embodiment, the present disclosure relates to a wood containing substrate having a water insoluble quinone compound wherein the water insoluble quinone compound is at least about 1.0 mm beneath the surface of the substrate.

In other embodiments, the present disclosure relates to a building material, paint or stain containing about 0.1 wt % to about 10 wt % of a quinone compound. In some embodiments, the building material, paint or stain contains less than or equal to about 5 wt % of anthraquinone.

### BRIEF DESCRIPTION OF THE DRAWINGS

FIG. 1 shows a photograph of Acorn woodpeckers drilling into a piece of window trim made from recycled plastic to store acorns.

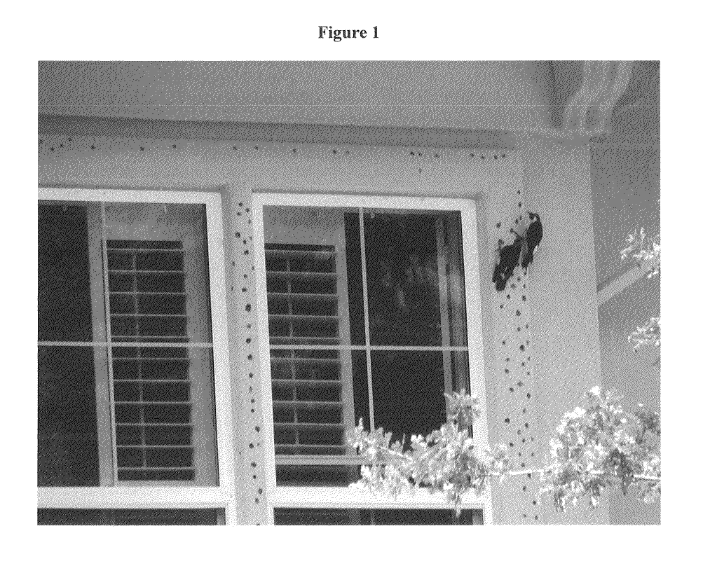

FIG. 2 shows the amount of wood damage by Pileated Woodpeckers over time for different material treated with AHQ.

FIG. 3 also shows the amount of wood damage by Pileated Woodpeckers over time for different material treated with AHQ.

FIG. 4 also show the amount of wood damage by Pileated Woodpeckers over time for different material treated with AHQ.

### DETAILED DESCRIPTION

The present disclosure relates to the use of various quinones to protect building materials from bird, pest or fungal damage. In particular, the disclosure relates to incorporating one or more quinone compounds in a building material to deter birds, pests or fungus from damaging such material.

In one embodiment, the present disclosure relates to a method of reducing or preventing damage to a wood-containing substrate, the method including applying to a surface of the substrate a first solution containing a water-soluble quinone compound to form a wetted substrate, such that the water-soluble quinone compound penetrates beneath the surface of the substrate, and converting the water-soluble quinone compound to a water-insoluble quinone compound, or derivative thereof.

Damage to wood-containing substrates, and even some non-wood-containing substrates, from birds, pests and fungus can be serious. For example, woodpeckers are notorious for their strong pointed beak that is used to penetrate wood in search of insects and hollow out wood for nesting. Woodpeckers often cause damage to building exteriors in search of food or shelter. Holes can be drilled into wood siding, eaves, window frames and trim boards. Other nesting birds, such as house wrens, tree swallows, barn swallows, pigeons, mourning doves, can either attach a nest to the side of buildings or hollow out space to support nests. In addition to the direct damage to the substrates, the nesting materials and remains of the bird feces (very acidic) can cause collateral damage to the building materials.

Similarly, termites can also cause extensive damage to wood-containing substrates. Termites feed and consume the wood. Left untreated, termite infested wood-containing substrates can be destroyed in a short amount of time. Carpenter ants and bees are another set of pests that can cause similar damage. For example, carpenter ants and carpenter bees can bore ¼ inch diameter holes in the underside of cedar decking to deposit one egg as a nesting chamber. The larvae does not consume wood but the repeated holes in the underside of railing and support members can weaken the deck.

Wood rotting fungi are present in most areas and can cause extensive damage to wood and wood containing substrates. Fungi can cause wood on houses to decay and crumble. White rot fungi (Daelalea flavida), Ganoderma fungi and Serpula lacrimans are some of the known fungi to cause such damage.

The present disclosure is related to reducing or preventing damage caused by these birds, pests and fungi. The reduction or prevention of such damage may be based on a native, untreated wood containing substrate or a substrate treated with conventional methods. In some embodiments, the damage to a wood containing substrate may be reduced by about 100%, or about 95%, or about 90%, or about 80%, or about 70% or about 60%, or about 50% or about 40%, or about 30%. In other embodiments, the reduction or prevention in damage may be effective for up to about 3 months after treatment, or about 6 months after treatment, or about 9 months after treatment, or about 1 year after treatment, or about 2 years after treatment or about 5 years after treatment. The measure of the damage reduction or prevention can be made by many means. For example, the reduction of damage may be measured by the increased working life of the substrate or the amount of time, effort or materials to repair the substrate.

In some embodiments, the present disclosure is effective to reduce or prevent damage to wood containing substrates (and non wood containing substrates) caused be woodpeckers, termites and/or white rot fungi.

The wood containing substrate can be a wood containing substrate that is protected from bird, pest or fungi damage by treatment with the method and composition of the present invention. The wood containing substrate can include a power pole, telephone pole, dimensional lumber, pressure treated lumber, shingles, siding (e.g., cedar siding) or other similar building materials. In one embodiment, the wood containing substrate is a power or telephone pole. The method and composition of the present disclosure can also be used as a replacement for pressure treated lumber.

Suitable quinone compounds for use in the present disclosure include quinone compounds that can be made water soluble for treatment and converted to a water insoluble form, and are effective for preventing or reducing damage to treated wood containing (or non wood-containing) substrates. Quinone compounds can include those listed in the table below and 9,10-dihydroxyanthracene, anthrahydroquinone, anthraquinone, 1,2-dihydroxy anthraquinone, 1,4-dihydroxy anthraquinone, naphthoquinone, anthrone(9,10-dihydro-9-oxo-anthracene), 10-methylene-anthrone, phenanthrenequinone, 6,11-dioxo-1H-anthra[1,2-c]pyrazole, anthraquinone-1,2-naphthacridone, 7,12-dioxo-7,12-dihydroanthra[1,2-b]pyrazine, 1,2-benzanthraquinone, 2,7-dimethylanthraquinone, 2-methylanthraquinone, 3-methylanthraquinone, 1-aminoanthraquinone, 1-methoxyanthraquinone, 2-carboxy-1,3,5,6,8-pentahydroxy-7-monosaccharide and other saccharides of anthraquinones or glucosamides, 2(1,3-dihydro-3-oxy-5-sulfo-2H-indol-2-ylidine)-2,3-dihydro-3-oxo-1H-indole-5-sulfonic acid, 1,8-dihydroxy-anthraquinone, 1-amino-anthraquinone, 1-chloro-anthraquinone, 2-chloro-anthraquinone, 2-chloro-3-carboxyl-anthraquinone, 1-hydroxy-anthraquinone, 9,10-dihydroanthrahydroquinone, 1,4-dihydroanthrahydroquinone, 1,4,4a,9a-tetrahydroanthrahydroquinone, 9,10-dihydroxyanthracene and water-soluble derivatives thereof. In one embodiment, the water-soluble quinone compound is the sodium salt of 9,10-dihydroxyanthracene.

Quinone compounds can also include naturally occurring anthraquinones, such as those listed in the table below, as well as Alaternin, Alizarin CAS 72-48-0, Aloe emodin CAS 481-72-1, Aloin, Anthragallol, Barbaloin, Calyculatone, Carminic acid CAS 1260-17-9, Cassiaside, Catenarin, Chrysazin, Chrysophanol CAS 481-74-3, Citreorosein, Danthron, Echinofuran, Emodic acid, Emodin CAS 518-82-1, Frangulin, Indigo carmine CAS 860-22-0, Islandicin, Kaempferol, Kermesic acid CAS 18499-92-8, Laccaic acid CAS 60687-93-6, Lucidin, Lupeol, Morindone, Munjistin, Musizin, Nepodin, Nordamnacanthal CAS 3736-59-2, Obstusin, Pachybasin, Parietin, Physcion CAS 521-61-9, Presengulone, Prinodin, Purpurin CAS 81-54-9, Pustuline, Questin, Quinizarin, Quinquangulin, Rhein CAS 478-43-3, Rubiadin, Rubrocristin, Sengulone, Shikonin, Skirin, Soranjidiol, Streptocarpone and Xanthorin.

| Scientific Name | Common Name | Anthraquinone Found | Location |
|---|---|---|---|
| Aloe confusa | Aloe (East Africa, | C-glycoside barbaloin | leaves |
| | Tanzania) | | |
| Artemisia annua | Wormwood | Emodin | leaves |
| Cassia alata | Candle Bush (SE Asia, | rhein, aloe emodin | leaves |
| | Nigeria, South America) | | |
| Cassia biflora | Twin-flowered cassia | Not specified “anthraquinone” | leaves |
| | (tropical americas) | | |
| Cassia fistula | Golden Shower Tree | Not specified “anthraquinone” | leaves |
| | (Southern Asia) | | |
| Cassia fistula | Golden Shower Tree | oxy-anthraquinone | Root bark |
| | (Southern Asia) | | |
| Cassia fistula | Golden Shower Tree | Not specified “anthraquinone” | leaves |
| | (Southern Asia) | | |
| Cassia fistula | Golden Shower Tree | rhein | fruit pulp |
| | (Southern Asia) | | |
| Cassia fistula | Golden Shower Tree | Rhein | leaves, pods |
| | (Southern Asia) | | |
| Cassia hirsuta | Wolly Senna (tropical | Not specified “anthraquinone” | leaves |
| | americas) | | |
| Cassia italica | Dog Senna, Italian | 1,5-dihydroxy-3-methyl | whole plant |
| | Senna | anthraquinone; 1,5-Dihydroxy-3- | |
| | | methoxy-7-methyl-anthraquinone | |
| Cassia nigricans | none | emodin, citreorosein, and emodic | leaves |
| | | acid | |
| Cassia obtusifolia | Sicklepod; coffeepod or | Physcion, emodin, rhein, among | seeds |
| | coffee weed | others | |
| Cassia occidentalis | Coffee weed (Brazil, | Emodin | root |
| | Nigeria) | | |
| Cassia occidentalis | Coffee weed (Brazil, | Emodin, oxymethyl | plant |
| | Nigeria) | anthraquinones | |
| Cassia occidentalis | Coffee weed (Brazil, | Emodin | seeds |
| | Nigeria) | | |
| Cassia occidentalis | Coffee weed (Brazil, | Not specified “anthraquinone” | leaves |
| | Nigeria) | | |
| Cassia podocarpa | podocarpa (Africa) | rhein, aloe emodin | leaves |
| Cassia rotundifolia | Round-leafed cassia | Not specified “anthraquinone” | leaves |
| | (Tropical and sub- | | |
| | tropical North and South | | |
| | America and Africa) | | |
| Cassia senna | Alexandrian Senna | chyrsophanol, aloe-emodin, and | young plant |
| | (Egypt, Sudan, Nigeria, | rhein | |
| | North Africa, India and | | |
| | China | | |
| Cassia sophera | Kasunda (India; tropical) | Not specified “anthraquinone” | leaves |
| Cassia sophera | Silver sands (Jamaica) | 1,8-dihydroxy-3,6-dimethoxy-2- | root bark |
| | | methyl-7-vinylanthraquinone, and | |
| | | 1,3-dihydroxy-5,7,8-trimethozy-2- | |
| | | methylanthraquinone | |
| Cassia sophera | Silver sands | 1,2,7-trihydroxy-6,8-dimethozy-3- | heartwood |
| | | methyl- and 1,2,6-trihydroxy-7,8- | |
| | | dimethoxy-3-methylanthraquinone | |
| Cassia tora | Wild Senna; Foetid | Not specified “anthraquinone” | leaves |
| | Cassia; Sickle Senna | | |
| | (India) | | |
| Gladiolus psittascinus | Maid of the mist; | 1,6,7-Trihydroxy-3-methoxy- | bulb |
| | dragon's head lily | 8methyl-anthraquinone; 1- | |
| | (Africa) | Hydroxy-3,6,7-trimethoxy-8- | |
| | | methyl-anthraquinone | |
| Heterophyllaea pustulata | Cegadera (Argentina and | Heterophylline (1,6-dihydroxy-7- | leaves |
| | Bolivia) | methoxy-2-methylanthraquinone) | |
| | | and Pustuline (2-hydroxy-3- | |
| | | methoxy-7-methylanthraquinone). | |
| Latuca sativa var. | Cabbage Lettuce; | Emodin, chrysophanol, physcion | leaves |
| capitata | iceberg salad | | |
| Morinda citrifolia L. | Noni (Southeast Asia) | Anthraquinone | root |
| Phaseolus vulgaris | Common bean or white | Emodin, chrysophanol, physcion | beans |
| | kidney bean | | |
| Pisum sativum | Gardenpeas | Emodin and physcion | peas |
| Plantagines lanceolatae | Plaintain herb | Emodin, chrysophanol, physcion | whole plant |
| Polygonum cuspidatum | Japanese knotfeed | Emodin monohydrate | roots |
| Polygonum multiflorum | Fo-ti (Chinese herb) | Emodin | root |
| Rhamnus alaternus | Mediterranean | Emodin | Fruits |
| | Buckthorn | | |
| Rhamnus alaternus | Mediterranean | 7.8 ± 2.8 ppm emodin | red fruits |
| | Buckthorn | | |
| Rhamnus alpinus | Alpine Buckthorn | Not specified “anthraquinone” | Leaves |
| | (Europe) | | |
| Rheum emodi | revand-chini (Himalayan | Rhein, Physcion, aloe-emodin and | Rhizomes |
| | species of Indian | chysophanol | |
| | Rhubarb) | | |
| Rheum emodi | Himalayan Rhubarb, | emodin and chrysophanic acid | roots, rhizomes |
| | Indian Rhubarb, red- | | |
| | veined pie plant | | |
| Rheum officinale | Chinese rhubarb | emodin and chrysophanic acid | roots, rhizomes |
| Rheum palmatum | Turkey rhubarb, East | emodin and chrysophanic acid | roots, rhizomes |
| | Indian Rhubarb | | |
| Rheum undulatum | Common rhubarb | Emodin, chrysophanol, physcion | leaves |
| Rhizoma graminis | Couch grass root | Emodin, chrysophanol, physcion | root |
| Rubia tinctorum | Common or dyer's | purpuroxanthin, quinizarin, | roots |
| | madder | purpurin, alizarin | |
| Rumex dentatus | Toothed dock | Emodin, aloe emodin, | roots |
| | | chrysophanol, physcion | |
| Rumex patientia | Monk's rhubarb, | emodin-6-O-β-D- | roots |
| | patience dock, garden | glucopyranosidde, chrysophanol, | |
| | patience (Eastern | physcion, emodin | |
| | Europe) | | |
| Senna alata (L.) | Christmas candle | Aloe-emodin, Rhein, emodin, | roots, leaves |
| | (Tropics including | chrysophanol | |
| | Africa, SE Asia, Pacific | | |
| | Islands and tropical | | |
| | America. | | |
| Senna corymbosa | Empress candle plant | 5,7′-biphyscion; hydroquinone | leaves |
| | | monomethyl ether, | |
| | | methoxyhydroquinone | |
| Senna lindheimeriana | Velvet leaf senna | chrysophanol, chrysophanol 8- | roots |
| | | methyl ether, emodin, physcion, | |
| | | xanthorin, questin, 1-hydroxy-3- | |
| | | methyl-2,6,7,8-tetra-methoxy- | |
| | | 9,10-anthraquinone | |
| Senna rugosa | Shrub (Brazil) | Chrysophanol, physcion, | roots |
| | | quinquangulin, and rubrofusarin | |
| Senna sophera | Sophera Senna (annual | Physcion, physcion bianthrone, | Seeds |
| | undershrub; India) | xanthorin, floribundone-1, | |
| | | isosengulone, sengulone, | |
| | | anhydrophlegmacin9,10-quinones, | |
| | | and presengulone. | |
| Sesamum indicum | Sesame Seed; Benne | anthrasesamone F ([Z]-6,7- | Seeds |
| | seed | dihydroxy-2-[6-hydroxy-4-methyl- | |
| | | 3-pentenyl]anthraquinone | |
| Sinningia speciosa | Gloxinia | 1-hydroxy-7-methoxy-2- | tubers |
| | | methylanthraquinone; 2-methyl-7- | |
| | | methoxyanthraquinone | |
| Vismia laurentii | Cameroon | laurentiquinone A; laurentiquinone | Fruits |
| | | B; laurentiquinone C; Emodin | |
| Vitis vinifera | Grape vine leaves | Emodin, chrysophanol, physcion | leaves |
| Xyris pilosa | Yelloweyed Grass | 3-methoxychrysazin, and 1,5- | leaves, stems |
| | (Brazil) | dihydroxy-3-methoxy- | |
| | | anthraquinone | |
| Aspergillus glaucus | Black Mold (fungus) | Physcion, physcionanthrone, | general |
| | | physcionanthrone B, and | |
| | | erythroglaucin | |
| Aspergillus glaucus | Black Mold (fungus) | novel anthraquinone derivative | general |
| | marine sediment derived | with naptho[1,2,3-de]chromene- | |
| | | 2,7-dione skeleton. | |
| Caloplaca erythrantha | Lichen | 7-chloroemodin | general |
| Caloplaca spp. | Lichens | Emodin, parietin, fallacinol, | general |
| | | fallacinal, parietinic acid, | |
| | | xanthorin, 2-choroemodin, fragilin, | |
| | | and 1-O-methylfragilin. | |
| Helminthosporium | Brown Spot (rice) | 1,4,5,8-tetra-hydroxy-2- | general |
| oryzae | | methylanthraquinone | |
| Phoma foveata | Potato gangrene | Pachybasin, chrysophanol, | general |
| | (Australia, Tasmania) | emodin, phomarin. | |
| Phoma sorghina | Endophytic fungus of | 1,7-dihydroxy-3-methyl-9,10- | general |
| | leaves of Mexican | anthraquinone; 1,6-dihydroxy-3- | |
| | sunflower | methyl-9,10-anthraquinone; 1,7- | |
| | | dihydoxy-3-hydroxymethyl-9,10- | |
| | | anthraquinone | |
| Ramularia collo-cygni | Leaf and awn spot | Rubellins (red and yellow | general |
| | (Barley) | anthraquinone derivatives) | |
| Teloschistes exilis | Lichen | Parietin | general |
| Xanthoria parietina | Common orange lichen | Parietin | general |
| Galeruca tanaceti | leaf beetle | Chrysazin and chrysophanol | eggs, larvae and |
| | | | adult hemolymph |
| Paranemastoma | Harvestmen (similar to | 2-methyl-9,10-anthraquinone, | prosomal scent |
| quadripunctatum | spider) | dimethyl-9,10-anthraquinone | glands |
| Galeruca tanaceti | Tansy leaf beetle | Chrysazin and chrysophanol | eggs, larvae and |
| | | | adults |
| Xanthogaleruca luteola | Elm leaf beetle | Chrysazin and chrysophanol | eggs, larvae and |
| | | | adults |
| Comatula pectinata | sea lilly, crinoid | 3-O-sulfate of 4-butyryl-1,3- | whole body |
| | | dihydroxy-6,8-dimethoxy-9,10- | |
| | | anthraquinone | |

The quinone compound can be selected from those disclosed in U.S. Pat. No. 5,728,898, including 9,10-anthraquinone, alkylated quinones such as 2-methylquinone; 2-ethylquinone; 2,3,5-trimethylquinone; 2-methylnaphthoquinone; 2-ethylnaphthoquinone; 2-propylnaphthoquinone; 2-methylanthraquinone; 2-ethylanthraquinone; 2-amylanthraquinone; 2-t-butylanthraquinone; or 2-(4-methyl-pentyl) anthraquinone, an alkenylated quinone compound such as 2-(4-methylpentenyl)anthraquinone, an alkoxylated quinone compound such as 1-methoxyanthraquinone or 1,5-dimethoxyanthraquinone, a phenyl-substituted quinone compound such as 2-phenylquinone, an alkylamino-modified quinone compound such as 2-(N,N-dimethylamino)anthraquinone, or a halogenated quinone compound such as 2-chloroquinone; 2,3-dichloronaphthoquinone, 1-chloroanthraquinone or 2-chioroanthraquinone

The quinone compound can be made water soluble and water insoluble using known methods, such as those in U.S. Pat. No. 5,728,898. For example, U.S. Pat. No. 5,728,898 discloses a process for making water-soluble hydroquinone salts. The disclosures in U.S. Pat. No. 5,728,898 are incorporated herein in their entirety.

The quinone compound can be applied to the substrate in the form of a solution. The solution can be an aqueous or semi-aqueous solution. The quinone compound can be soluble or semi-soluble in the solution. Depending on the pH of the solution the quinone compound can be soluble or partially soluble. The partially soluble quinone can exist as either suspended crystalline particles, fine particles, colloidal particles, etc. For example, 9,10-anthrahydroquinone sodium salt can exist at a high pH (e.g., pH 11 or more) and is readily soluble in aqueous solutions. At slightly basic or neutral pH values, 9,10-anthrahydroquinone without the sodium salt (e.g, —ONa groups are —OH groups) can exist and is only slightly soluble or insoluble in aqueous solutions. This compound can exist in solution as particles, crystals, colloids, etc. In some embodiments, the semi-aqueous or non-aqueous solutions containing suitable particles, crystals, colloids, etc. can be used to achieve penetration of a quinone compound into and under the surface of a substrate.

The solution can be applied to the substrate using known techniques, such as coating, spraying, dipping, soaking, and knifing and pressure treatment. In one embodiment, the water soluble quinone is soluble in a first aqueous solution. The first aqueous solution is applied to the substrate by soaking the substrate in the first solution. In some embodiments, the application of the quinone compound to the substrate is done in an oxygen reduced or oxygen free environment. For example, a wood pole or piling can be held under reduced pressure to remove water from the pool or piling. The pole or piling is then cut or knifed to increase penetration of the subsequent pressure treatment of the pole or piling with the first solution.

The water-soluble quinone compound should have a water solubility in the first aqueous or semi-aqueous solution of greater than about 1%. In one embodiment, the water-soluble quinone compound has a solubility in the first aqueous or semi-aqueous solution greater than about 5%, and more particularly greater than about 10%. The solubility of the quinone compound can be based on the pH of the solution. In one embodiment, the first solution has a pH of a greater than about 7, or about 7.5 or about 8, or about 8.5 or about 9, or about 9.5, or about 10, or about 10.5, or about 11, or about 11.5, or about 12. The pH of the solution can be adjusted using metal hydroxides, such as KOH and NaOH, or buffers, such as bicarbonates.

The application of the first solution to the substrate can be done under standard temperature and pressure conditions, or can be done under elevated temperature or pressure conditions. For example, the first solution can be applied at a temperature greater than about 20° C., or about 24° C., or about 30° C., or about 35° C., or about 40° C., or about 50° C., or about 60° C., or about 70° C., or about 80° C., or about 90° C., or about 100° C. The first solution can also be applied within a temperature range. The temperature range can be a range based on the values provided, such as between about 60° C. and about 80° C. In some embodiments, the first solution can be applied at a pressure equal to or greater than about 1, 2, 3, 4, 5, 6, 7, 8, 9, 10, 11, 12, 13, 14, or about 15 atm. These values can also define a range, such as between about 8 and about 12 atm.

In one embodiment, the application of the first solution to the substrate is sufficient to allow the water-soluble quinone compound to penetrate beneath the surface of the substrate. The first solution can be applied for a time greater than about 30 seconds, or about 1 minute, or about 5 minutes, or about 10 minutes, or about 20 minutes, or about 30 minutes. In other embodiments, the application time is short to allow for the treatment of many substrates in a short time period. For example, a short application time can be when the substrate is being pressure treated. The first solution can be applied for a time less than about 30 minutes, or about 30 minutes, or about 10 minutes, or about 5 minutes, or about 1 minutes, or about 30 seconds. The application time can also be a time interval according to any of these times. For example, the application time can be from about 30 seconds to about 5 minutes. The first solution can also be applied within a time range. The time range can be a range based on the values provided, such as between about 20 and about 30 minutes. In other embodiments, the application time can be extended, such as when a pole or piling is being soaked with the first solution under standard temperature and pressure. The first solution can be applied for a time greater than about 1 hour, 2 hours, 4 hours, 12 hours, 24 hours, 48 hours, or about 72 hours.

A wetted substrate is a substrate that after treatment with the first solution has a portion of the water soluble quinone compound applied beneath the surface of the substrate. The surface of the substrate is the area of the substrate that is readily exposed to air or liquid that contacts the surface of the substrate. A water soluble quinone compound applied beneath the surface of the substrate is a compound that is greater than about 1 mm, 1.2 mm, 1.4 mm, 1.6 mm, 1.8 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 15 mm, 20 mm, or about 25 mm beneath the surface of the substrate. These values can also be used to define a range of the depth of penetration, such as between about 2 mm and 5 mm. The water soluble quinone compound can penetrate from mm to cm beneath the surface of the substrate depending on the substrate, the compound and the treatment conditions. In some embodiments, the quinone compound is between about 0.5 mm and 5 mm, or about 1.0 mm and 3.0 mm, or about 2 mm beneath the substrate surface. In other embodiments, the water soluble quinone compound can penetrate the entirety of the substrate. In a pressure treated pole or piling, the water soluble quinone compound can penetrate to the center of the substrate.

The water soluble quinone compound can be converted to a non water soluble quinone compound, or derivative thereof, by known methods. The water soluble quinone compound can be made water insoluble by exposure to, or the application of, an aqueous or semi-aqueous solution having a pH value wherein the compound is non water soluble. In some embodiments, the solution can have a pH of less than about 12.5, or about 12, or about 11.5, or about 11, or about 10.5 or about 10. Similar to the first solution, this second solution can be applied to the substrate using known techniques, such as coating, spraying, dipping, soaking or knifing and pressure treatment.

The water soluble quinone compound can also be converted to a non water soluble quinone compound, or derivative thereof, by exposure to air (e.g., oxygen). The wetted substrate can be left out in air to dry or placed in a drying chamber. In some embodiment, any oxidizing substance, such as the water with dissolved air, can be sufficient to achieve the required conversion.

Optionally, after the first solution is applied to the substrate and before the second solution is applied, the substrate can be washed or rinsed with another solution that does not contain the water-soluble substrate. The wash or rinse step can remove the water-soluble compound from the surface of the substrate prior to converting to a water insoluble form. In one embodiment, the wash or rinse can remove substantially all of the water soluble compound from the surface and not remove substantially all of the water soluble compound beneath the surface of the substrate. In another embodiment, the wash or rinse can remove substantially all of the water soluble compound from the surface and not remove the water soluble compound present beneath the surface of the substrate to a level that renders it ineffective to reduce or prevent damage to the substrate from birds, pests or fungus. After the rinse or wash step, the amount or concentration of water-soluble compound retained beneath the substrate surface is sufficient to reduce or prevent damage after being converted to a water insoluble form.

Optionally, after the water soluble quinone compound has been converted to a water insoluble quinone compounds, or derivative thereof, the surface of the substrate can be rinsed, washed or treated to remove any water insoluble quinone compound on the surface. In one embodiment, the rinse solution can be oxygenated or aerated water, a buffered solution in water, or an oxidizer such as a slight acidic wash, provided the resulting salt would be innocuous (e.g., HCl, which leaves sodium chloride as a residue). In another embodiment, the surface can be treated with an alcohol rinse.

In one particular embodiment, the present disclosure relates to a method of reducing or preventing damage to a wood-containing power pole, the method comprising soaking the power pole in an anthrahydroquinone solution having a pH of greater than about 11 to form a wetted power pole, such that the anthrahydroquinone penetrates beneath the surface of the power pole, and converting the anthrahydroquinone to 9,10-anthraquinone.

The present disclosure also relates to the addition of a quinone compound to non wood substitutes, such as those for construction and trim lumber. The construction industry has increasingly turned to non wood and composite materials for exterior trim, decking, interior trims and decorative moldings for commercial and residential buildings. Some birds and pests do not differentiate wood from non wood materials. These materials can be protected from bird and/or pest damage by the addition of a quinone compound to the non wood or composite material. For example, a quinone compound can be added to plastic architectural pieces used on exteriors of buildings as corbels and roof trim enhancements. In one embodiment, the present disclosure relates to the use of quinone compounds (e.g., AQ, poly cyclic quinones, and other quinone bird repellents) as additives to non wood trim and decking materials to prevent birds from creating nests and pecking holes in them.

In a further embodiment, the substrate can be a piling, such as a piling for use in marine or aqueous environments. The substrate can be a wood containing piling for use in piers or docks. The embodiments of the present disclosure can replace creosote-treated wood. Creosote is a mixture of hydrocarbon compounds used to protect wood products. Unfortunately slow solution of some creosote components and physical breakdown of the treated wood leads to toxicity in the surrounding water and sediment. Creosote is also slowly soluble in water and as a dense fluid, will slowly migrate down the pole into the sea bed leaving the pole exposed. Other options, such as treatment with CCA (chromated copper arsenate) or ACZA (ammoniacal copper zinc arsenate), are considered a biohazard in the marine environment because of slow leaching and eventual release of toxins into the water column.

In one embodiment, the application for marine and aquatic wood pilings can prevent or reduce the destruction of the wood by various organisms. These organisms can include Teredindae (ship worm) which is a mollusk that can burrow as far as 14 inches per year and leave a bore size up to ¼ inch; Limnoria which is a crustacean of around ⅛ to ¼ inches long that can dig through about 1″ of wood per year; Martesia; Chelura; and Spaeroma. These organisms can also include marine and aquatic fungi, such as Basidiomycetes, Ascomycetes, Chytrich, and Mitosporic.

In another embodiment, the present disclosure relates to a building material comprising about 0.1 wt % to about 10 wt % of a bird repellent compound. The building material can be a non wood building material. The building material can include plastic or recycled plastic, such as polyethylene, polypropylene, polybutylene, polystyrene or mixtures thereof. The building material can be formulated with or extruded with the quinone compound. The building material can contain about 0.1 wt %, 0.2, 0.3, 0.4, 0.5, 0.6, 0.7, 0.8, 0.9, 1.0, 1.5, 2.0, 2.5, 3.0, 3.5, 4.0, 4.5, 5.0, 6.0, 7.0, 8.0, 9.0 or about 10 wt % of the quinone compound. These values can also be used to define a range, such as about 0.3 wt % to about 0.6 wt %. In particular, the building material can contain about 0.5 wt % to about 5 wt %, or about 1 wt % to about 3 wt % quinone compound. In other embodiments, the building material contains less than or equal to about 0.1 wt %, or less than or equal to about 0.2 wt %, or less than or equal to about 0.5 wt %, or less than or equal to about 0.1 wt %, or less than or equal to about 2 wt %, or less than or equal to about 5 wt % quinone compound.

The bird repellent compound of the present disclosure incorporated into a building materials can be selected from other known bird repellent compounds as well as the quinone compounds provided above. Such other bird repellent compound include, but are not limited to, methyl anthranilate, terpenes such as limonene and d-pulegone.

The present disclosure also relates to a paint or stain containing a quinone compound that can prevent or reduce bird or pest damage. The amount of quinone compound in the paint or stain can vary depending on the paint or stain, the quinone compound and intended use of the paint or stain. The paint or stain can contain about 0.1 wt %, 0.2, 0.3, 0.4, 0.5, 0.6, 0.7, 0.8, 0.9, 1.0, 1.5, 2.0, 2.5, 3.0, 3.5, 4.0, 4.5, 5.0, 6.0, 7.0, 8.0, 9.0 or about 10 wt % of the quinone compound. These values can also be used to define a range, such as about 0.3 wt % to about 0.6 wt %. In some embodiments, the paint or stain contains about 0.5 wt % to about 5 wt %, or about 1 wt % to about 3 wt % quinone compound. In other embodiments, the paint or stain contains less than or equal to about 0.1 wt %, or less than or equal to about 0.2 wt %, or less than or equal to about 0.5 wt %, or less than or equal to about 0.1 wt %, or less than or equal to about 2 wt %, or less than or equal to about 5 wt % quinone compound.

The paint or stain can be applied to surfaces to prevent or reduce bird or pest damage. In another embodiment, the present disclosure relates to a method of reducing or preventing damage to a substrate, the method including applying to a surface of the substrate a paint or stain containing a quinone compound.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

### Example 1

Overview. A series of caged Pileated woodpecker trials are conducted using power pole segments both untreated and treated with a quinone. The treatment segments contain the quinone compound in a range of concentrations. The quinone compound is also applied by either painting or soaking. The quinone compound is applied in a high pH solution (i.e., in a water soluble form). Thereafter, the segments are treated with a lower pH solution to convert the quinone to a water insoluble form. The bird's preference to nest building excavation for each segment is measured. Both the soaked and painted segments show lower incidence of nesting evacuation.

Testing was designed to evaluate the efficacy of anthrahydraquinone (AHQ) as a Pileated woodpecker repellent under controlled conditions. AHQ was tested in a two-choice test followed by a one-choice test. Twelve Pileated woodpeckers which showed a consistent pattern of damage to utility pole sections were selected. Each Pileated woodpecker was housed and tested in an indoor enclosure approximately 3 (H)×3 (W)×5 (L) m.

At the start of the test, each Pileated woodpecker was presented with two untreated utility pole sections, 25-30 cm×120 cm (approximately 12.5 square feet), placed on metal stands, for 4 preconditioning days. Each pole was positioned 0.6 m from the back and sidewalls of the enclosure so that the poles in each cage are separated by about 1.3 m. A 15 cm (W)×15 cm (H)×2 m (L) plastic divider was placed between the poles to prevent wood chips that woodpeckers remove from poles from mixing. At 1600 on day 4, the poles were removed from the test enclosure. On day five at 0800, new poles were placed in the enclosure. One pole was untreated and the other treated with AHQ at concentrations as described in the present disclosure. The post-treatment analysis was conducted for 6 days.

The initial placement of the treated and the untreated poles in each enclosure was randomly determined. On each subsequent day of the test, the position of each pole was switched with each other to reduce any bias. At the beginning of each test day, starting on day 2 (0800), woodpecker damage to each pole was measured by collecting and weighing the wood chips that were removed. Before being weighed, wood chip samples were placed in a drying oven for 24 hours to standardize the moisture content. Also, a video camera was placed in selected enclosures to document woodpecker-pecking behavior on untreated and treated poles. The camera recorded woodpecker activity on poles for during the first two hours of each day during the test period. Analysis of the recordings looked for changes in bird behavior, e.g. bill wiping, regurgitation, pecking and perching.

The weight of wood chips removed by Pileated woodpeckers follow a three-factor repeated measures design, where observations are repeated on each bird for all three factors: treatment (chemical) time (pre and post-treatment), and pole (control and treated)). All data was analyzed as mixed liner models. SAS PROC MIXED was used to conduct the analysis.

At the conclusion of the 2-choice test, the untreated pole was removed from the enclosure and the treated pole was positioned in the center of the enclosure for the remaining test period of 6 days or until Pileated woodpeckers quit removing wood chips from the pole. The same analysis was conducted for this test period.

Pole treatments were conducted by an external source prior to shipping to the National Wildlife Research Center. The depth of the treatment concentration on the ends of the pole verses the sides of the pole can differ due the nature of the wood grain in the pole. Prior to testing, the top of the treated pole was covered with a shield to prevent access by Pileated woodpeckers. In addition, at the conclusion of the test period a small diameter (0.5 cm) core sample was taken from each treated pole to determine the depth of chemical penetration.

The poles used were approximately 10 inches in diameter and about 4 feet long. A plastic drain pipe sufficiently wide to hold the pole was capped at one end and cut to a length such that the pole will fit inside. The poles were treated in the container with the pole prepositioned inside the cylinder and the pipe secured in an upright position. If additional liquid is required to cover the pole, 10% NaOH in water was be used. A clear covering was placed over the top of the pipe once it was filled. This allowed the liquid level to be observed so that if additional liquid was needed as the product is absorbed by the pole, it was observed and additional 10% sodium hydroxide solution was be added. The cover also prevented additional air from oxidizing the soluble AQ.

The poles were soaked for 48 hours. The liquid contents of the cylinder were decanted into a bucket at the conclusion. The treated poles were rinsed twice in water before being removed to air dry. The surface characteristics of the treated pole were recorded, such as the depth of treatment, treatment in the cracks of the surface and on the surface. In addition to the treatment of poles by immersion, some poles were treated by a applying the treatment using a disposable paint brush. Some oxidation was observed using his application method.

The measurement taken during the experiments included the mass balance of the quinone by oxidizing the quinone from the decanted liquid from the immersion of the pole. This was done by measuring the exact volume of the quinone (e.g., Aquinone) added to the initial container. At 10.5% the quinone in the liquid, the quinone added to the container was known. The decanted liquid was oxidized back to the quinone in air or by adding water to the material until the color red was completely gone. Filtering this liquid and weighing the quinone after drying allowed the calculation of the quinone that was applied to the pole. The pH of the surface of the pole after rinsing to insure it is neutral was done with litmus paper. The depth of penetration into the pole was determined by drilling ½ inch hole in the pole to observe the tan color of the quinone (e.g., AQ) that was visible in the outer layer of the wood. Painting a quinone on the surface of the pole also allowed timing of the conversion process in air from soluble to insoluble AQ. The reaction is colorimetric. The surface changed from deep red, to green and eventually to tan. The tan is the insoluble AQ end point.

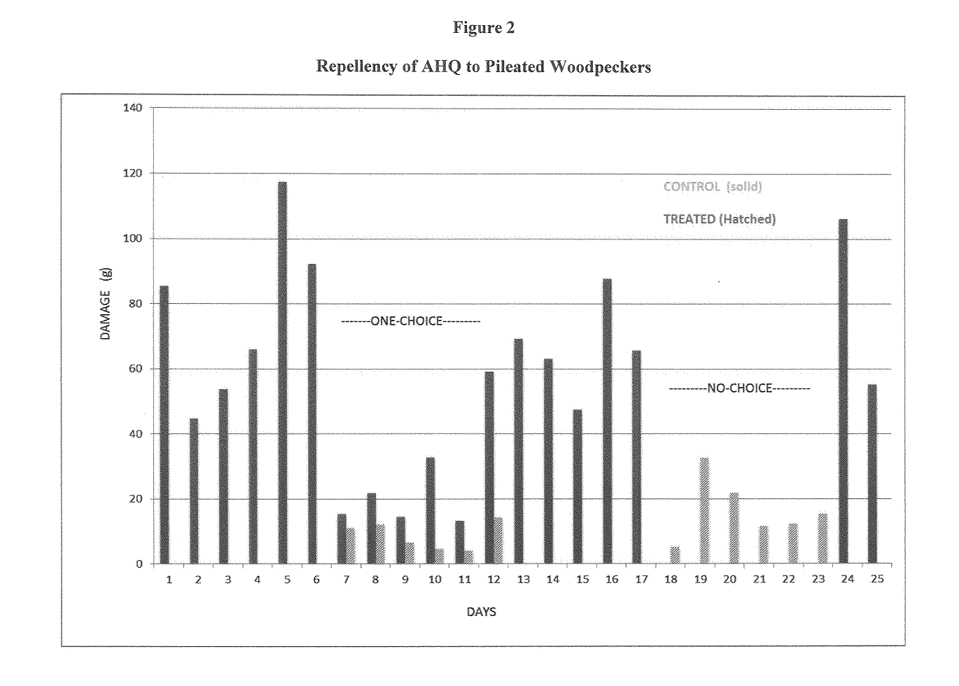

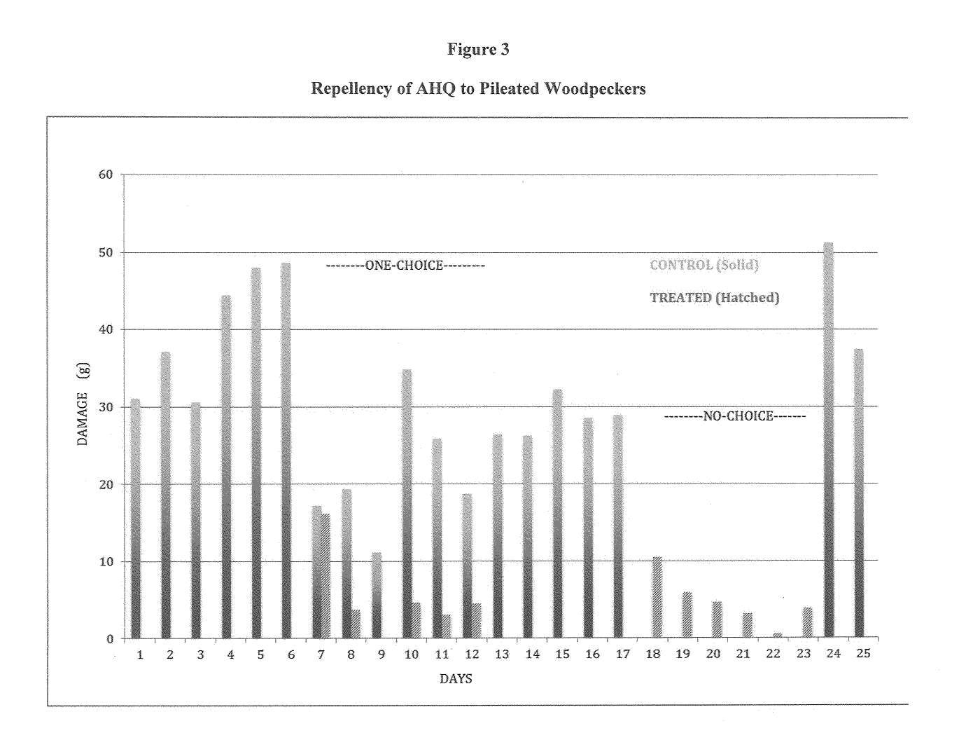

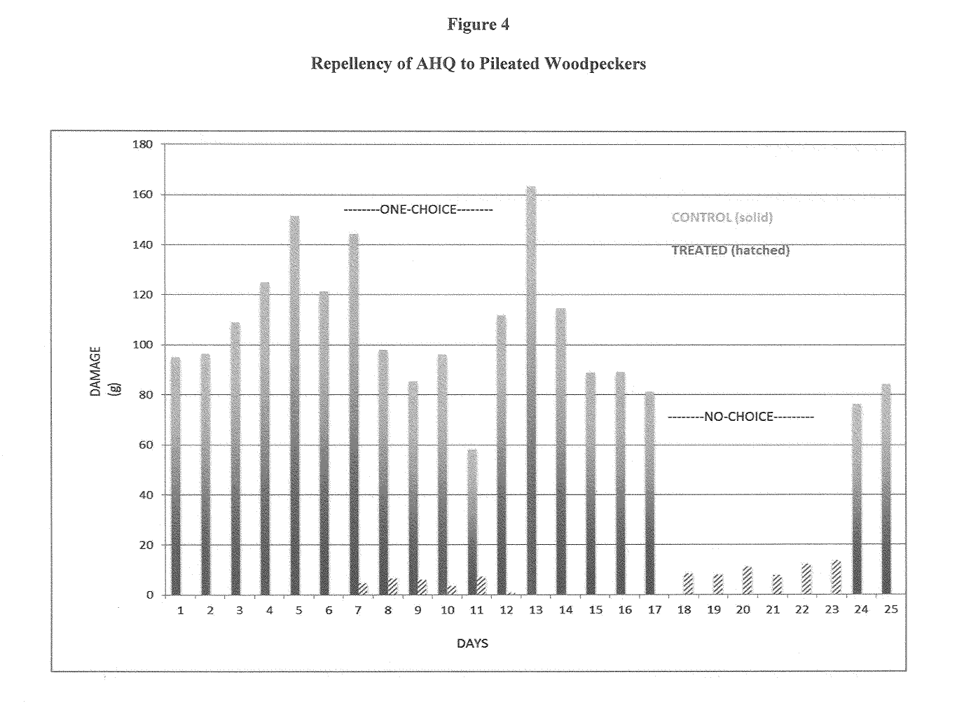

FIGS. 2-4 show the results of the study. The extent of the wood chip removal by the Pileated woodpeckers is a measure of the effectiveness of the treatment. As is evident from the figures, the weight of wood chips removed from poles treated with AHQ were surprisingly less than the weight of wood chips removed from untreated poles.

### Example 2

### Treatment of a power pole with 9,10-dihyroxyanthracene

A power pole made from southern yellow pine is treated with a sodium salt of 9,10 dihyroxyanthracene (also known as AHQ or anthrahydroquinone) to render the pole resistant to pest and/or fungal damage. The sodium salt of 9,10 dihyroxyanthracene is stable in an oxygen free and high pH environment (e.g., above pH 11). In the high pH solution, the compound has a solubility of around 10% (wt/v). A 10% solution of AHQ is prepared in an aqueous solution having a pH of about 12. The pole is soaked in the bath of 10% AHQ for about 20-30 minutes at 70-80° C. with little or no air exposure. A portion of the AHQ penetrates into the top layer of the pole. The depth of penetration can range from 1 mm to 200 mm.

After soaking, the pole is transferred to a water tank where the surface would be neutralized. The water having a nominal pH of about 7. Alternatively, the pole is dried in air without rinsing. AHQ is unstable in the presence of air (e.g., oxygen) unless it is maintained in a high pH solution. If exposed to a lower pH or air (e.g., oxygen), the AHQ can be converted to 9,10 anthraquinone (also known as AQ). AQ is insoluble in almost every solvent including water. Therefore, AQ precipitates out of solution and becomes trapped in the top layer of the pole. AQ forms both on the surface and inside the wood fibers of the upper layers of the pole. This outer layer of pole is now both termite and woodpecker proof Because anthraquinones can be effective fungicides, the pole is now also fungi proof.

While this disclosure has been particularly shown and described with reference to example embodiments thereof, it will be understood by those skilled in the art that various changes in form and details may be made therein without departing from the scope of the invention encompassed by the appended claims.

We claim:

1. A method of reducing or preventing damage to a wood containing substrate, the method comprising:
(i) applying to a surface of the substrate a first solution containing a water soluble quinone compound to form a wetted substrate, such that the water soluble quinone compound penetrates beneath the surface of the substrate, and
(ii) converting the water-soluble quinone compound to a water insoluble quinone compound, or derivative thereof.

2. The method of claim 1, wherein the damage is caused by birds, termites or fungi.

3. The method of claim 1, wherein the wood containing substrate is a power pole, telephone pole, dimensional lumber, pressure treated lumber, piling, shingles, siding or other building materials.

4. The method of claim 1, wherein the first solution has an pH of greater than about 7.

5. The method of claim 1, wherein at least about 1% of water-soluble quinone compound is present in the first solution.

6. The method of claim 1, wherein the water-soluble quinone compound is selected from the list consisting of 9,10-dihydroxyanthracene, anthrahydroquinone, anthraquinone, 1,2-dihydroxy anthraquinone, 1,4-dihydroxy anthraquinone, naphthoquinone, anthrone(9,10-dihydro-9-oxo-anthracene), 10-methylene-anthrone, phenanthrenequinone, 6,11-dioxo-1H-anthra[1,2-c]pyrazole, anthraquinone-1,2-naphthacridone, 7,12-dioxo-7,12-dihydroanthra[1,2-b]pyrazine, 1,2-benzanthraquinone, 2,7-dimethylanthraquinone, 2-methylanthraquinone, 3-methylanthraquinone, 1-aminoanthraquinone, 1-methoxyanthraquinone, 2-carboxy-1,3,5,6,8-pentahydroxy-7-monosaccharide and other saccharides of anthraquinones or glucosamides, 2(1,3-dihydro-3-oxy-5-sulfo-2H-indol-2-ylidine)-2,3-dihydro-3-oxo-1H-indole-5-sulfonic acid, 1,8-dihydroxy-anthraquinone, 1-amino-anthraquinone, 1-chloro-anthraquinone, 2-chloro-anthraquinone, 2-chloro-3-carboxyl-anthraquinone, 1-hydroxy-anthraquinone, 9,10-dihydroanthrahydroquinone, 1,4-dihydroanthrahydroquinone, 1,4,4a,9a-tetrahydroanthrahydroquinone, 9,10-dihydroxyanthracene and water-soluble derivatives thereof.

7. The method of claim 1, wherein the water-soluble quinone compound is the sodium salt of 9,10-dihydroxyanthracene.

8. The method of claim 1 wherein the water-soluble quinone compound penetrates at least about 0.5 mm beneath the surface of the substrate.

9. The method of claim 1, wherein the water-insoluble quinone compound is converted to a water-insoluble compound by applying to the surface of the wetted substrate a second solution having pH less basic than the first solution.

10. The method of claim 1, wherein the second solution has a pH of less than about 7.

11. The method of claim 1, wherein the water insoluble quinone compound is 9,10-anthraquinone.

12. The method of claim 1,
wherein the wood containing substrate is a power pole;
wherein the first solution is an anthrahydroquinone solution having a pH of greater than about 7;
wherein the first solution is applied by soaking the power pole to form a wetted power pole, such that the anthrahydroquinone penetrates beneath the surface of the power pole, and wherein the anthrahydroquinone is converted to 9,10-anthraquinone.

13. A cellulosic based substrate comprising a water insoluble quinone compound wherein the water insoluble quinone compound is at least about 1.0 mm beneath the surface of the substrate.

14. The cellulosic based substrate of claim 13, wherein the substrate is a power pole, telephone pole, dimensional lumber, pressure treated lumber, piling, shingles, siding or other building materials.

15. The cellulosic based substrate of claim 13, wherein the quinone compound is selected from the list consisting of 9,10-dihydroxyanthracene, anthrahydroquinone, anthraquinone, 1,2-dihydroxy anthraquinone, 1,4-dihydroxy anthraquinone, naphthoquinone, anthrone(9,10-dihydro-9-oxo-anthracene), 10-methylene-anthrone, phenanthrenequinone, 6,11-dioxo-1H-anthra[1,2-c]pyrazole, anthraquinone-1,2-naphthacridone, 7,12-dioxo-7,12-dihydroanthra[1,2-b]pyrazine, 1,2-benzanthraquinone, 2,7-dimethylanthraquinone, 2-methylanthraquinone, 3-methylanthraquinone, 1-aminoanthraquinone, 1-methoxyanthraquinone, 2-carboxy-1,3,5,6,8-pentahydroxy-7-monosaccharide and other saccharides of anthraquinones or glucosamides, 2(1,3-dihydro-3-oxy-5-sulfo-2H-indol-2-ylidine)-2,3-dihydro-3-oxo-1H-indole-5-sulfonic acid, 1,8-dihydroxy-anthraquinone, 1-amino-anthraquinone, 1-chloro-anthraquinone, 2-chloro-anthraquinone, 2-chloro-3-carboxyl-anthraquinone, 1-hydroxy-anthraquinone, 9,10-dihydroanthrahydroquinone, 1,4-dihydroanthrahydroquinone, 1,4,4a,9a-tetrahydroanthrahydroquinone, 9,10-dihydroxyanthracene and water insoluble derivatives thereof.

16. The cellulosic based substrate of claim 13, wherein the water insoluble quinone compound is 9,10-anthraquinone.

17. A building material comprising about 0.1 wt % to about 10 wt % of a bird repellent compound.

18. The material of claim 16, wherein the building material is non wood containing.

19. The material of claim 16, wherein the building material comprises plastic or recycled plastic.

20. The method of claim 16, wherein the bird repellent is a quinone compound, or derivative thereof.
